(19) United States
(12) Patent Application Publication
(10) Pub. No.: US 2005/0044893 A1
(43) Pub. Date: Mar. 3, 2005

(54) Process for making low-OH glass articles and low-OH optical resonator

(76) Inventors: Jeffrey Coon, Corning, NY (US); John E. Lasala, Painted Post, NY (US); Candace J. Quinn, Corning, NY (US); Robert Sabia, Corning, NY (US); Ronald L. Stewart, Big Flats, NY (US); James E. Tingley, Swain, NY (US); Ljerka Ukrainczyk, Painted Post, NY (US); Joseph M. Whalen, Corning, NY (US)

Correspondence Address: CORNING INCORPORATED, SP-TI-3-1, CORNING, NY, 14831, US

(21) Appl. No.: 10/926,619

(22) Filed: Aug. 25, 2004

Related U.S. Application Data
(60) Provisional application No. 60/523,252, filed on Nov. 18, 2003.
(60) Provisional application No. 60/498,541, filed on Aug. 28, 2003.

(51) Int. Cl. C03B 37/00; H01S 3/081

(52) U.S. Cl. 65/32.1; 65/32.2

(57) ABSTRACT

Disclosed are optical resonators having low OH content in at least the near-surface region and a process for making low OH glass article by chlorine treatment of consolidated glass of the article. Cl₂ gas was used to remove OH from depth as deep as 350 μm from the surface of the consolidated glass. The process can be used for treating flame-polished preformed optical resonator disks. A new process involving hot pressing or thermal reflowing for making planar optical resonator disks without the use of flame polishing is also disclosed.

### CROSS-REFERENCE TO RELATED APPLICATIONS

This application claims the benefit of priority under 35 U.S.C. § 119(e) of U.S. Provisional Application Ser. No. 60/523,252 filed on Nov. 18, 2003 and U.S. Provisional Application Ser. No. 60/498,541 filed on Aug. 28, 2003.

### FIELD OF THE INVENTION

The present invention relates to articles having a low OH level in at least the near-surface region thereof and processes for making such articles. In particular, the present invention relates to fused silica-based optical resonators having a low OH level in at least the near-surface region thereof and processes for making the same. The invention is useful, for example, in the production of fused silica disks having low OH level for use as optical resonators in optical oscillators.

### BACKGROUND OF THE INVENTION

RF oscillators can be constructed by using both electronic and optical components to form opto-electronic oscillators (“OEOs”). See, e.g., U.S. Pat. No. 5,723,856 to Yao and Maleki and U.S. Pat. No. 5,777,778 to Yao. Such an OEO includes an electrically controllable optical modulator and at least one active opto-electronic feedback loop that comprises an optical part and an electrical part interconnected by a photodetector. The opto-electronic feedback loop receives the modulated optical output from the modulator and convert it into an electrical signal to control the modulator. The loop produces a desired delay and feeds the electrical signal in phase to the modulator to generate and sustain both optical modulation and electrical oscillation in radio frequency spectrum when the total loop gain of the active opto-electronic loop and any other additional feedback loops exceeds the total loss.

OEOs use optical modulation to produce oscillations in frequency spectral ranges that are outside the optical spectrum, such as in RF and microwave frequencies. The generated oscillating signals are tunable in frequencies and can have narrow spectral linewidths and low phase noise in comparison with the signals produced by other RF and microwave oscillators. Notably, the OEOs are optical and electronic hybrid devices and thus can be used in optical communication devices and systems.

A variety of OEOs can be constructed based on the above principles to achieve certain operating characteristics and advantages. For example, another type of OEOs is coupled opto-electronic oscillators (“COEOs”) described in U.S. Pat. No. 5,929,430 to Yao and Maleki. Such a COEO directly couples a laser oscillation in an optical feedback loop to an electrical oscillation in an opto-electronic feedback loop.

Improved OEOs are disclosed in U.S. Pat. No. 6,567,436 to Yao, wherein it discloses an opto-electronic oscillator that implements at least one high-Q optical resonator in an electrically controllable feedback loop. An electro-optical modulator is provided to modulate an optical signal in response to at least one electrical control signal. At least one opto-electronic feedback loop, having an optical part and an electrical part, is coupled to the electro-optical modulator to produce the electrical control signal as a positive feedback. The electrical part of the feedback loop converts a portion of the modulated optical signal that is coupled to the optical part of the feedback loop into an electrical signal and feeds at least a portion of it as the electrical control signal to the electro-optical modulator.

The high-Q optical resonator may be disposed in the optical part of the opto-electronic feedback loop or in another optical feedback loop coupled to the opto-electronic feedback loop, to provide a sufficiently long energy storage time and hence to produce an oscillation of a narrow linewidth and low phase noise. The mode spacing of the optical resonator is equal to one mode spacing, or a multiplicity of the mode spacing, of the opto-electronic feedback loop.

The optical resonator may be implemented in a number of configurations, including, e.g., a Fabry-Perot resonator, a fiber ring resonator, and a microsphere resonator operating in whispering-gallery modes. These and other optical resonator configurations can reduce the physical size of the OEOs and allow integration of an OEO with other photonic devices and components in a compact package such as a single semiconductor chip. It is disclosed in U.S. Pat. No. 6,567,436 that the whispering-gallery-mode resonator's cavity can comprise a transparent micro sphere, a ring, or a disk. Quality-factor of such resonators is limited by optical attenuation in the material and scattering on surface inhomogeneities, and thus the material for use as the resonator can be any of a variety of dielectric materials, however the preferred material is fused silica which is a low loss material for optical fibers.

Microsphere fused silica glass resonators have certain characteristics which make them suitable and particularly desirable for use in OEOs. Particularly, these characteristics include exceptionally high quality (“Q”) factors, and small dimensions (diameters less than 10 mm, thicknesses of less than 100 microns and curvature radius of less than 50 microns). Although thickness uniformity and flatness are not required features, they are critical in the periphery where the light circulates, and thus require tight process control. Although conventional fused silica works better than other dielectric materials, water in the near-surface results in the attenuation of the optical signal, reduction of the Q of the resonator and the addition of noise to the resonant signal produced by the OEO.

Conventionally fused silica disks for use in resonators are formed by precision double-side polishing, followed by flame polishing of the disk side wall. Double-side polishing is very labor intensive and costly. Flame polishing is limited in side wall radius generation by surface tension as dictated by flame temperature and glass softening point; as such control of the wall radius is difficult. Additionally, both double-side and flame polishing introduce water and other impurities into the near-surface region of the silica resonator disks.

The present inventors have discovered a new process for making glass articles having a low-OH level at least in the near-surface region. This process is particularly useful for producing fused silica-based resonators mentioned above.

### SUMMARY OF THE INVENTION

Thus, according to a first aspect of the present application, it is provided a process for making a consolidated glass article having a low β-OH level at least in the near-surface region, comprising at least one chlorine treatment step of subjecting the consolidated glass of the article to a chlorine-containing atmosphere at an elevated temperature for an effective amount of time.

Preferably, in the process of the present invention, the glass article produced has a β-OH level of lower than 100 ppm, preferably lower than 50 ppm, more preferably less than 30 ppm, still more preferably less than 10 ppm, most preferably less than 1 ppm, in the portion within at least 10 μm, preferably at least 50 μm, more preferably at least 100 μm, still more preferably at least 200 μm, still more preferably at least 300 μm, from the surface of the article, and most preferably throughout the body of the article.

Preferably, in the process of the present invention, the glass article is made of fused silica glass, optionally doped with alumina, boron oxide, fluorine, germania and/or titania, at an amount of up to 5% by weight each. More preferably, the glass is doped with germania.

Preferably, when the article is made of fused silica-based glass, the chlorine containing atmosphere is selected from chlorine and chlorine/inert gas mixtures, such as chlorine mixture with nitrogen, argon, neon or helium; the chlorine treatment temperature is at least 800° C., preferably at least 1000° C.; and the chlorine treatment time is at least 2 hours, preferably at least 4 hours, more preferably at least 8 hours.

The chlorine treatment at an elevated temperature may be carried out before the glass article is formed. Alternatively, the chlorine treatment may be carried out after the article is formed, or multiple chlorine treatment steps are carried out to treat the consolidated glass both before and after the glass article is formed. The temperature and durations in those multiple chlorine treatment steps may vary.

Of particular interest in the process of the present invention, the glass article is a glass optical resonator. The resonator can take a planar shape, such as a thin cylindrical disk, or a flat ring-shaped disk, or a spherical shape. Where the resonator is planar shaped, it has a curved outer rim having a curvature radius.

In one embodiment of the process of the present invention, an optical resonator having low OH level at least in the near-surface region is produced. The optical resonator, prior to the chlorine treatment of process of the present invention, has a flame polished rim having a β-OH level of at least 100 ppm in the portion within at least 100 μm from the surface. The process of the present invention can be used to reduce the β-OH level of the rim of this resonator to a low level of lower than 80 ppm in the portion within at least 50 μm from the surface, advantageously lower than 50 ppm, more advantageously less than 30 ppm. In one embodiment, the resonator is subjected to a Cl₂/He mixture treatment at approximately 1000° C. for at least 2 hours.

The process of the present invention, when used in the context of producing a planar optical resonator, i.e., an optical resonator having the shape of a thin cylinder or ring, can comprise the following steps in sequence:
(i) providing a cylindrical shaped glass preform having a predetermined size;
(ii) optionally lapping, grinding and/or polishing the preform;
(iii) optionally subjecting the preform to chlorine treatment;
(iv) dicing the preform to form disks of a predetermined thickness;
(iv′) optionally lapping and/or polishing the disks;
(v) optionally subjecting the disks to chlorine treatment;
(vi) hot pressing the disks or thermally reflowing the disks at an elevated temperature; and
(vii) cooling the disks to room temperature.

In a preferred embodiment, after step (vi), an additional chlorine treatment step (vi′) is carried out:
(vi′) subjecting the disks thus formed to chlorine treatment.

Preferably, step (vi) is carried out in an environment essentially free of water. Such an environment can be a dry inert gas ambient, e.g., N2, He, Ar, Ne and mixtures thereof, or vacuum. In one embodiment, step (vi) involves hot pressing at a temperature where the glass has a viscosity less than 10¹⁰ poise, more preferably between 10⁷ and 10¹⁰ poise. Preferably, step (vi) involves hot pressing at a pressure ranging from 1,000 to 1,500 psi. In another embodiment, step (vi) involves thermal reflowing at a temperature where the glass has a viscosity less than 10⁸ poise, preferably ranging from 10⁶ to 10⁷ poise.

According to a second aspect of the present invention, it is provided a glass optical resonator for use in an opto-electronic oscillator having a low OH content at least in the glass in the near-surface region. In one embodiment of the present invention, the resonator is made of optionally doped fused silica glass, which has a β-OH level of less than 80 ppm, preferably less than 50 ppm, more preferably less than 30 ppm, still more preferably less than 10 ppm, most preferably less than 1 ppm, in the portion within at least 10 μm, preferably at least 50 μm, more preferably at least 100 μm, still more preferably at least 200 μm, still more preferably at least 300 μm, from the surface of the article, and most preferably throughout the body of the resonator. In one embodiment, the resonator of the present invention is made of a fused silica material containing additional dopant material selected from the group consisting of boron, fluorine, aluminum and germanium. In a preferred embodiment, the resonator is made of germania-doped fused silica glass, with the content of GeO₂ up to 5% by weight of the glass. This GeO₂ doped glass is advantageously photo-refractive, meaning that, a refractive index change in this glass can be induced by exposure to certain radiation, for example, UV radiation, over a certain fluence. Optionally H₂ can be doped into the glass in order to enhance the photo-refractive property of the glass. In a preferred embodiment, a photo-induced grating having differing refractive index from that of the rest of the resonator is written into the resonator. In one embodiment, the resonator has a planar circular disk shape or a ring shape, having an outer diameter of about 1 to 10 mm, preferably about 5 mm, and a thickness of from about 20 to 200 μm, preferably about 50 to 100 μm, and a curved rim having a curvature radius of from about 25 to 50 μm.

The present invention has the advantage of providing glass articles having a low β-OH level by chlorine treatment of the consolidated glass. Thus the low β-OH level can be obtained either before of after the glass article is formed. The present invention is particularly advantageous in producing optical resonators, especially optical resonator disks, having a precision surface and thickness, low defects, a curved rim having a lower curvature radius and low OH level, at a relatively low cost. The low OH resonator of the present invention features high Q and low phase noise.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitutes a part of this specification.

### BRIEF DESCRIPTION OF THE DRAWINGS

FIG. 1 is a schematic illustration of the side view of a fused silica disk prior to pressing according to one embodiment or the process of present invention for making planar shaped optical resonators;

FIG. 2 is a schematic illustration of the top plan view of the fused silica disk illustrated in FIG. 1;

FIG. 3 is a schematic illustration of the side view of pressed glass disk with locations of healed surface/subsurface damages indicated thereon according to one embodiment of the process of the present invention for making planar shaped optical resonators;

FIG. 4 is a schematic illustration of a magnified rim portion of the pressed glass disk illustrated in FIG. 3;

FIG. 5 is a schematic illustration of the top plan view of the pressed glass disk illustrated in FIG. 3;

FIG. 6 is a schematic illustration of an example of optical resonator operating in whispering-gallery-mode in connection with two prisms;

FIG. 7 is a schematic illustration of an example of optical resonator operating in whispering-gallery-mode in connection with two optical fibers; and

FIGS. 8 and 9 are plots of measured OH level in relation to the distance from the center of disks of two sample disks treated with flame polishing before chlorine treatment, after 2 hours of chlorine treatment, and after 10 hours of chlorine treatment, of the present invention, respectively.

### DETAILED DESCRIPTION OF THE INVENTION

Using chlorine-containing atmosphere for producing low OH level fused silica material has been known to those skilled in the art. However, the present inventors believe that hitherto such processes involve drying silica soot particles obtained via, for example, OVD processes prior to consolidation thereof into bulk fused silica glass. Those soot particles before consolidation are very fine particles having a diameter well below 1 μm. It is relatively easy to dry those fine soot particles in chlorine containing atmosphere at an elevated temperature given the spacing between the soot particles. Usually, in those prior art processes, the thus chlorine dried soot particles are consolidated at a high temperature to form fused silica boules having a low OH level throughout the whole body. Such boules are further processed to form end product articles, such as stepper lenses, photomask substrates, and the like. In certain steps of forming such optical articles, the materials are put into an environment which can lead to the formation of OH in the article, particularly on the article surface and/or in the near-surface region, for example, when articles are ground, lapped or polished in an aqueous medium. It is desired to reduce the OH level thus introduced in certain applications.

However, the extension of chlorine treatment to reducing OH level of a consolidated glass, especially a preformed glass article, does not seem practical for a number of reasons. First, this is because the penetration depth of such OH reducing effect of such chlorine treatment, and thus the overall effectiveness of such chlorine treatment in reducing OH level of a bulk glass, is subjected to doubt. Second, such chlorine treatment may lead to the degradation of surface quality of the preformed glass article. The present inventors investigated the present invention of using chlorine-containing atmosphere to treat glass articles or glass materials already consolidated and containing a relatively high OH content, and discovered that, unexpectedly, substantial reduction of OH level within a depth of up to several hundred μm can be obtained, and that such treatment is not detrimental for fused silica-based glass articles. This discovery, inter alia, serves as the basis of the process of the present invention.

The present invention is first directed at a process for making glass articles having low OH level at least at the near-surface region. As used herein, a low OH level is a measured β-OH level of lower than 100 ppm, preferably lower than 80 ppm, more preferably less than 50 ppm, still preferably less than 10 ppm, most preferably less than 1 ppm. Low OH level in certain glass articles is desired, especially in certain optical elements where the absorption of OH is of concern. In certain optical elements, such as in an optical resonator, the propagation of light, or the travel of light, is substantially restricted to the near-surface region. Thus low OH level in the near-surface region of those glass articles are particularly desired. The process for making glass articles having a low OH level, at least in the near-surface region, of the present invention is particularly advantageous in producing such optical elements in which a low OH level, especially in the near-surface region, is desired. Particularly, the process of the present invention can be used for producing articles having a low OH level, defined supra, in the region within at least 10 μm, preferably at least 50 μm, more preferably at least 100 μm, still more preferably at least 200 μm, yet still more preferably at least 300 μm, from at least part of the article surface, and most preferably throughout the body of the article. Such glass articles can include any glass material. In a preferred embodiment, they are fused silica-based articles. Fused silica is a material used in many optical elements for its excellent transmission in a wide wavelength band, low thermal expansion, and other properties. The fused silica may be prepared by various methods, such as sol gel processes, OVD process, flame hydrolysis, and the like. The fused silica material may be further doped, for example, by boron oxide, alumina, germania, fluorine, titanium, H₂, O₂, and the like.

The process of the present invention involves at least one step of chlorine treatment. As used herein, the term “chlorine treatment” means a step of subjecting the consolidated glass to a Cl₂ containing atmosphere at an elevated temperature for an effective amount of time. Depending on the nature of the glass material, the initial OH content in the glass material, the Cl₂-containing atmosphere, and desired OH level after treatment, the temperature and duration of chlorine treatment may vary. Indeed, multiple chlorine treatment steps may be employed at different stages of the process of the present invention in making the low OH glass article. For example and for the purpose of illustration only, where the glass article is made of fused silica and contains an initial β-OH of about 120 ppm in the region within about 150 μm from the surface, a chlorine treatment in the presence of an atmosphere of 5% Cl₂ in Cl₂/He mixture at an elevated temperature of approximately 1000° C. for a duration of approximately 2-8 hours may be required to obtain a β-OH level of lower than 80 ppm in the region within 150 μm from the surface of the article. Thus the process of the present invention is useful in producing any glass article in which at least a near-surface region having a low OH content is desired.

The process of the present invention may be used to produce many glass articles for which a low OH level, at least in the near surface region, is desired. However, of particular interest is the application of the process in the production of low OH optical resonators for use in optical oscillators. The process of the present invention will be described in more detail in connection with the production of fused silica-based optical resonators. However, it is to be understood that, although the process of the present invention is particularly advantageous for producing optical resonators, especially fused silica-based resonators, the process of the present invention is not limited to the production of fused silica-bases optical resonators.

In an optical resonator, light travels along and through the near-surface regions. Absorption/attenuation of light in these regions, and the surface homogeneity of the resonator are critical factors determining the phase noise and Q value of the resonator. For resonators operating at certain wavelength, it is highly desirable to reduce the OH level at least in the near-surface regions.

Conventionally fused silica disks for use in resonators are formed by precision double-side polishing, followed by flame polishing of the disk side wall. Double-side polishing is very labor intensive and costly. Flame polishing is limited in side wall radius generation by surface tension as dictated by flame temperature and glass softening point; as such control of the wall radius is difficult. Additionally, both double-side and flame polishing introduce water into the resonator, especially the flame polished rim, leading to a high OH level. For example, in fused silica-based resonator disks, the curved rim may contain an OH level of up to 120 ppm in the near-surface region within 100-200 μm from the curved surface of the rim, which is too high.

The instant inventors have discovered that, by subjecting the resonators thus formed to chlorine treatment at an elevated temperature, for example, at least 800° C., preferably approximately 1000° C., for an effective amount of time, for example, at least 2 hours, the OH level in the near surface region can be substantially reduced, to a level of lower than 80 ppm in the near-surface region within 100-200 μm from the curved surface. Generally, the higher the treatment temperature and the longer the treatment time, the more the OH level can be reduced, and the deeper the OH reduction effect can reach under the surface. However, it should be noted that the treatment temperature should be lower than the softening temperature of the disk material to prevent it from deforming. Since the chlorine treatment is carried out in a Cl₂ containing atmosphere, all surface area is subjected to the same condition. So it can be contemplated that the present process can be used for producing optical resonators having a disk, ring or spherical shape, where OH level of the interested near-surface region will be reduced.

The present inventors have also discovered that such chlorine treatment of those preformed resonators having a flame-polished surface with high surface quality does not negatively affect the surface quality, despite of the caustic nature of Cl₂. It is known that the surface quality of an optical resonator is critical for low phase noise and high Q. Therefore, the process of the present invention is particularly advantageous for the production of optical elements requiring a high precision such as optical resonators.

Another embodiment of the process of the present invention in producing planar optical resonators comprises the following steps in sequence:
(i) providing a cylindrical shaped consolidated glass preform having a predetermined size;
(ii) optionally lapping, grinding and/or polishing the preform;
(iii) optionally subjecting the preform to chlorine treatment;
(iv) dicing the preform to form disks of a predetermined thickness;
(iv′) optionally lapping and/or polishing the disks;
(v) optionally subjecting the disks to chlorine treatment;
(vi) hot pressing the disks or thermally reflowing the disks at an elevated temperature; and
(vii) cooling the disks to room temperature.

In one particular embodiment of this process, after step (vi), an additional step (vi′) is carried out:
(vi′) subjecting the disks to chlorine treatment.

As used herein, the term “planar optical resonator” means an optical resonator having planar surfaces. Thus a planar optical resonator can be a cylindrical disk having two circular planar surfaces, or a ring shaped disk having two circular ring-shaped surfaces. These disks should have a curved outer rim in which the stored light will travel. A spherical resonator does not contain a planar surface, thus is not included in the definition of the term “planar optical resonator.”

In the above laid-out steps of the process for making planar optical resonators, the steps (i) to (vii) were performed in sequence. As used herein, “in sequence” means that the next step is performed after the preceding step is finished, or in the middle of the immediately preceding step, or simultaneously with the immediately preceding step where possible and necessary. Additional optional operations, not mentioned in the above sequence, may be carried out between adjacent steps outlined above.

The steps will be described in relatively more details as follows:

In step (i), a cylindrical shaped glass preform is provided. For the production of solid resonator disks (i.e., not ring-shaped), the preform is solid. For the production of ring-shaped resonator disks, the preform may have a hollow cavity. This hollow cavity can be produced by core drilling of a solid preform. The preform can be, for example, a consolidated fiber preform. The production of fiber preform, by methods such as OVD, is well known by one skilled in the art. The fiber preform may be advantageously of low OH content per se, by, for example, chlorine treatment of the soot particles prior to consolidation thereof into glass as is known in the art. To obtain a predetermined size of the preform, a fiber preform can be drawn into a thinner cane. The preferred method of forming this preform involves utilizing the SiO₂ soot deposition or OVD “waveguide” process for forming a single uniform composition (i.e. no core) preform. The fused silica preform is consolidated and thereafter drawn into cane of the desired starting diameter. As mentioned supra, the fused silica may be doped with alumina, boron oxide, fluorine, titania, and/or germania in amount of up to 5% by weight each. Such dopants can function to modify the refractive index, transmission and laser durability of the finished resonator glass. The dopant can also function to lower the softening temperature and/or viscosity of the glass and modify the surface energy of the silica glass when thermal treated in step (vi) by hot pressing or thermal reflowing. However, in any event, the dopants should not unduly increase the attenuation of the light by the glass.

Where the glass preform provided in step (i) has a desired surface quality and diameter homogeneity, it can be used directly in step (iv) and diced into disks having predetermined desired thickness. However, it is difficult, if not impossible, to control the preform drawing process to such a degree that a precise preform cane can be obtained without the necessity of further processing before dicing. Thus, the optional step (ii) is often required. In this step, the glass cane preform is subjected to lapping, grinding and/or polishing such that a high surface smoothness and desired diameter with high homogeneity are achieved. Since the diameter of the cane determines the diameter of the finalized resonator disk after the subsequent steps, it is important that the cane is of a precise diameter with high diameter homogeneity.

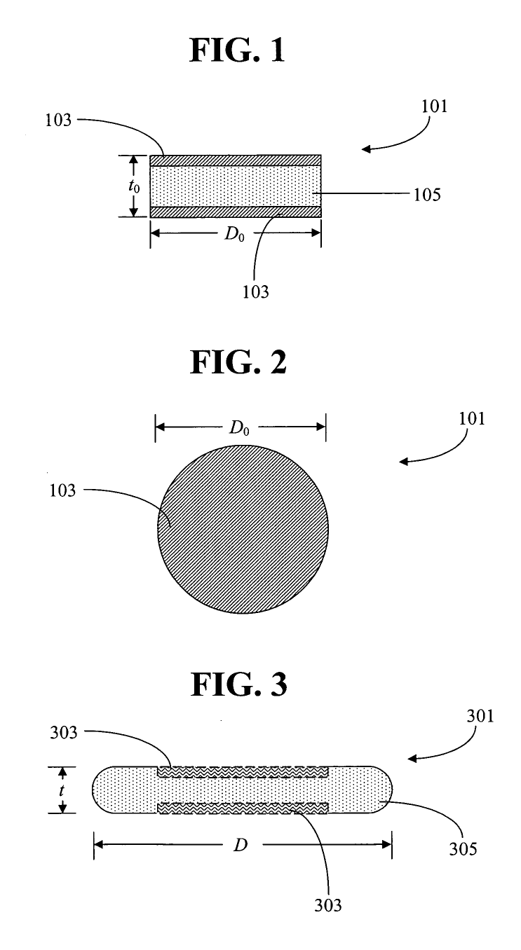

In step (iv), the cane is diced into disks having desired thickness. Again, since the thickness of the thus diced disks determines the thickness of the finalized resonator disks after all the subsequent steps, it is important that the thickness of the diced disks are precisely and homogeneously the desired thickness. An ID saw or wire saw may be used for the dicing. FIGS. 1 and 2 schematically illustrate the diced disks, designated as 101 in both figures. FIG. 1 is a schematic illustration of the side view of the disk 101, and FIG. 2 is a schematic illustration of the top plan view of the disk. The dicing usually results in areas 103 having surface and/or sub-surface defects. Between the affected areas 103 is the intermediate part 105 not affected by dicing. The disk has a predetermined thickness t₀ and an outer diameter D₀.

After the dicing step (iv), an optional step (iv′) of lapping and/or polishing of the disks may be performed, in order to reduce the surface and sub-surface damage and/or defects in areas 103.

Prior to or after the dicing step (iv), an optional chlorine treatment step (iii) or (v) is carried out. If step (ii) and (iv′) of lapping, grinding and/or polishing is carried out, which usually entails the use of an aqueous medium that may introduce OH to the surface of the preform, either step (iii) or (v) should be carried out in order to reduce OH thus introduced, provided that step (vi′) is not carried out. If the dicing step (iv) involves the use of an aqueous medium or the optional lapping/polishing step (iv′) is carried out, it is preferred that step (v) is performed. Steps (iii) and (v) may be both carried out, especially if step (ii) or (iv′) is carried out, and step (iv) involves the use of an aqueous medium.

After the disks of the predetermined dimension t₀ and D₀ are produced and optionally chlorine treated, they are then subject to a thermal treatment in step (vi) to cause the disk to reflow to form the glass disk with the desired diameter and thickness. Because of the surface energy of the glass, the edges (rims) tend to round. For a resonator, a rounded edge (rim) with desired curvature radius is critical. As mentioned above, in conventional resonators, such rounded rims are created by flame polishing in which the rim reflows and rounds due to surface tension as a result of the high temperature flame.

In one embodiment the “thermal” processing step (vi) involves placing the disks in a furnace and hot pressing the disks, between precision flat plates, at a temperature such that the glass viscosity is less than 10¹⁰ poise; and preferably between 10⁷ and 10¹⁰ poise. Assuming the aforementioned softening point temperature reducing dopant, for example, boron, is added to the based fused silica-based glass composition, the temperature range for achieving the preferred viscosity range is between 1250-1550° C. Generally, a higher temperature, thus a lower viscosity, is desired to facilitate the pressing. However, too high a temperature will cause unwanted reactions between the setter and the disk surfaces, causing surface and sub-surface defects to the pressed disks.

The hot pressing pressure, preferably about 1000-1500 psi, can be applied either with a static load or dynamically with hydraulics, screw drive, or other mechanical means.

It is preferred that this hot pressing step takes place in an water-free environment which can be achieved by hot pressing the disks in an atmosphere comprising an inert gas; e.g., a high purity, at least 99.99% pure, nitrogen, argon, or helium atmosphere. Alternatively, the water-free hot pressing atmosphere can be achieved by hot pressing in a vacuum atmosphere.

One additional consideration in the hot pressing step is that additional control of the thickness may be achieved through the use of mechanical stops; these are most useful in the control of pressure and the thermal cycle (time/temperature).

Preferred pressing plate material should be chosen based on thermal conductivity; i.e., it should be sufficient to draw heat uniformly from both surfaces during cooling, thus minimizing induced stress that results in bow (i.e., avoidance of the Twyman effect). Graphite (such as a high density POCO graphite or vitreous graphite) is a preferred platen or hot press material; it not only has the requisite of thermal conductivity, but also has sufficient glass release properties. Colloidal graphite release agents may be used to assure release from the platen.

An alternative to hot-pressing in step (vi) involves a thermal reflow process. In this thermal reflow embodiment the disks are heated on a precision flat plate having setters; again the thermal process should be done in a water-free, inert gas or vacuum, environment. It is preferred that this thermal reflow process is accomplished at a temperature where the glass viscosity is <10⁸ poise; more preferably this reflow step should be done at a temperature whereby the glass viscosity is preferably between 10⁷ and 10⁶ poise.

The preferred material for the precision flat plates and setters of the thermal reflow apparatus is the same as that for the hot pressing plate material, e.g., graphite.

Regardless of the “thermal” step utilized, either hot pressing or thermal reflow, the final dimensions are dictated/controlled, and are a function of the starting dimensions and the process time and temperature. Inherent to both the hot pressing and thermal reflow process is that as the disk is pressed or flows, glass from inside the disk center is pressed outward, such that the disk edge surface becomes rounded and is composed of glass that was originally inside the diced part. As such, it must be empirically determined what initial dimensions and what process conditions are necessary to result in disks which exhibit the desired final thickness, diameter and curvature dimensions.

Both the hot pressing and thermal reflow methods described above result in the following: (1) Surface damage on the disk faces heals during the thermal (pressing or reflow) process; (2) Disk sides become rounded as a result of surface tension; and, (3) Side wall rounding is controlled by the final thickness, surface tension, and glass viscosity, each of which, in turn, are functions of temperature, time or mechanical stops, glass composition, atmosphere and gas pressure, and setter plate surface material.

FIGS. 3, 4 and 5 schematically illustrate the pressed or reflowed disk resulting from the disk preform illustrated in FIGS. 1 and 2. In FIGS. 3, 4 and 5, the pressed disks, designated as 301, has a thickness t and an outer diameter D. Areas 303 substantially correspond to areas 103 of the disk 101 before pressing in FIGS. 1 and 2. However, after the thermal treatment, the surface and/or sub-surface damages in areas 103 are at least partially healed. In addition, rounded rim portion 305 having a curvature radius r is produced. Typically, t<t₀, and D>D₀.

To ensure the essentially water (or OH) free condition of the fused silica glass, as described above, either the perform and/or discs may be coated with a hydrophobic material, such as a silane, for example, a methyl or phenyl silane, which prevents water pick up on the surface. The hydrophobic material, which may be present as a coating or as a monolayer, will burn off during the hot pressing or thermal reflow process.

A step (vi′) of chlorine treatment may be carried out after the thermal treatment of step (vi). This step (vi′) is performed on the formed (pressed or reflowed) resonator disk. Where a step (vi′) is performed, steps (iii) and (v), which involve chlorine treatment, may be dispensed with. However, it is to be understood that any one or any combination of steps (iii), (v) and (vi′) can be used, as long as the desired OH level in the at least near-surface region of the resonator can be achieved. It is to be understood that step (vi′) may be carried out in conjunction of step (vii), i.e., the chlorine treatment can be carried out during the cooling cycle of the thermal treated glass disks. In any event, at least one step of chlorine treatment is performed in producing the final resonator disk.

Once the disks are formed to the proper dimensions (i.e., thickness, diameter and curvature), the disks can then be cooled to room temperature to form low OH resonator disks in step (vii). Particularly the cooling cycle should be designed such that the discs are annealed and stress-free when removed from the furnace.

Cooled disks are then inspected for defects and control of diameter, thickness, thickness uniformity, flatness, rim radius and OH level. It is also contemplated that after step (vii), a further step of chlorine treatment may be carried out, either in lieu of step (vi′) performed after step (vi), described supra, or in addition to step (vi′).

Advantages of this process over the current flame polishing process include: (1) The initial glass composition can be optimized in terms of OH and impurity levels, with significant advantages over commercial HPFS for transmission in the IR region of the spectra; (2) The initial glass composition can be selected so as to optimize processing temperature, viscosity, and surface tension; (3) the initial composition can be one which allows the final disk to exhibit photorefractive behavior and thus enable the incorporation of grating on the resonator; (4) the process does not introduce water or other impurities into the glass; and (5) the process is such that it results in an improvement in the control of the critical dimensions for this resonator application, i.e. edge radius and diameter.

Another benefit of the previously described “thermal” process for forming the low water silica disk resonators is that these processes are capable of producing resonators which exhibit the same high quality factors Q of conventionally produced resonators; as high as 10⁴-10⁵ disks. The very high quality factors Q of fused silica microspheres or disks may be attributed to several factors. One factor is that the fused silica dielectric material used for these disk/microspheres exhibits ultra-low optical loss at the frequencies of the supported whispering gallery modes; e.g., resonators operating at wavelengths near 1.3 and 1.5 microns at which the optical loss is low. Another factor is that the surface of the sphere or disk is specially fabricated to minimize the size of any surface inhomogeneities, e.g., on the order of a few Angstroms by a process that does not involve conventional, and expensive fire polishing. The high index contrast in microsphere cavities is also used for steep reduction of radiative and scattering losses with increasing radius.

Thus the glass optical resonator of the present invention for use in an opto-electronic oscillator has a low OH level at least in the near surface region. The resonator of the present invention, which can be planar or spherical, has a β-OH level of less than 80 ppm, preferably less than 50 ppm, more preferably less than 30 ppm, still more preferably less than 10 ppm, most preferably less than 1 ppm, in the region within at least 10 μm, preferably at least 50 μm, more preferably at least 100 μm, still more preferably at least 200 μm, still more preferably at least 300 μm, most preferably throughout the body of the resonator. In a preferred embodiment of the resonator of the present invention, the resonator is a low-water content fused or synthetic silica glass which includes in its composition a dopant for reducing the softening point so as to facilitate thermal processing. Specific dopant for this effect includes boron oxide in amounts up to 5% by weight. The dopants can be alumina, boron oxide, fluorine, germania, titania and combinations thereof.

Differences in radius of curvature for the silica disks can be controlled/modified by changes in surface energy at the solid-to-liquid and liquid-to-gas (i.e., setter-to-glass and glass-to-gas, respectively) interfaces. This glass surface energy may be modified by addition of certain dopants (up to 5%, by weight) including for example boron, fluorine, titania, alumina and germanium. It should be noted that these same dopants, described supra, function as well to lower the softening temperature which is critical to the thermal processing of the disks.

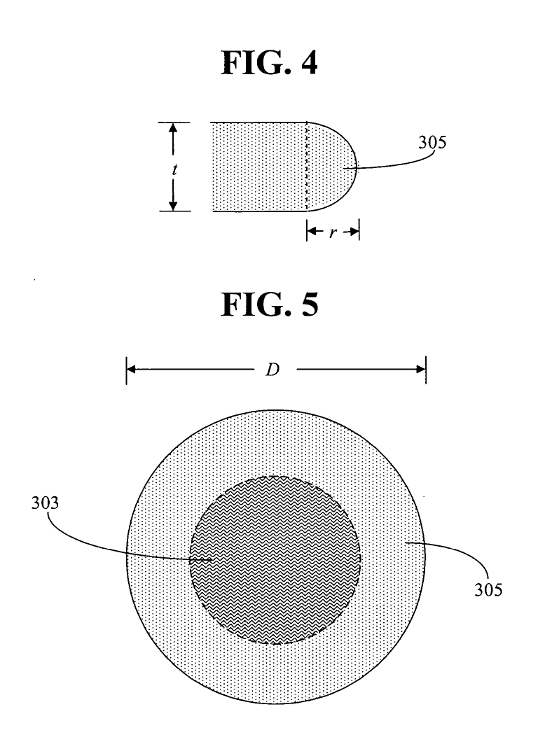

A preferred disc size of the aforementioned resonator disc is 50-100 microns in thickness (t in FIGS. 3 and 4 ), with a rounded side wall specification of 25-50 microns radius of curvature (r in FIG. 4), and a diameter tolerance of ½ micron.

For those applications where it is useful to integrate a grating on the resonator disc or microsphere, the glass composition may be selected from those which exhibit photorefractive behavior, for example, germanium-doped silica (up to 5%, by weight). In other words, the addition of germania to the composition provides a three fold advantage: softening point temperature reduction, surface energy modification and photorefractive behavior. Hydrogen may be added to provide optimized photorefractive behavior, this is achieved by hydrogen loading coupled with a UV exposure (e.g., 254 nm Hg lamp treatment) which functions to develop the grating. This hydrogen diffusion, into the disc, should be completed under pressure, specifically a pressure sufficient to increase the diffusion rate. In particular, this hydrogen diffusion should be performed on the finished disc after thermal treatment necessary to form the edge radius.

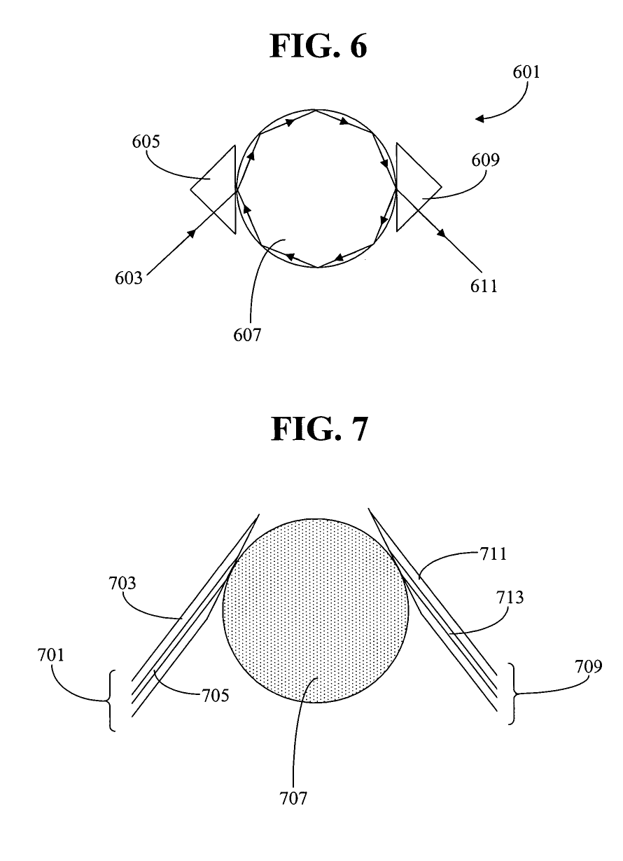

FIGS. 6 and 7 illustrate two embodiments of a micro whispering-gallery-mode resonator in operation. FIG. 6 shows a micro whispering-gallery-mode resonator 601 which includes a transparent microsphere, a ring, or a disk 607, comprised of the fused silica material described above, and two optical couplers 605 and 609. Quality-factor of such resonators is limited by optical attenuation in the material and scattering on surface inhomogeneities, and can be as high as 10⁴-10⁵ in micro-rings and disks, and up to 10¹⁰ in microspheres. Each coupler 605 or 609 may be a prism or in other forms. As is shown in FIG. 6, light signal 603 enters into the resonator 607 through the coupler 605, then travels along the circumference (near-surface region) of the resonator, such as the curved rim portion of a disk or ring resonator. At a predetermined time, the signal is allowed to exit the resonator as output signal 611 through the other coupler 609.

It is predicted that the effective path length of a micro resonator of a few hundreds of microns in diameter operating at 1550 nm can be as long as 10 km, limited by the intrinsic attenuation of the material. It has also been shown that high-Q microspheres and disks comprised of low water fused silica can effectively replace fiber- optic delays in the OEO with a length up to 25 km, which corresponds to a Q factor of 19 million at 30 GHz. Such a high Q resonator can be used to achieve a phase noise of less than -60 dB at 1 Hz away from a 30 GHz carrier in an OEO to meet the requirement of deep space Ka band communication.

FIG. 7 shows an alternative microsphere or disk resonator 707 using two waveguides 701 and 709 as the couplers. The end surfaces of both waveguide couplers 701 and 709 are cut at a desired angle and are polished to form micro-prisms. The two waveguide couplers 701 and 709 may be implemented by using two waveguides formed in a substrate which can be used to integrate the OEO on a single chip. The two waveguide couplers 701 and 709 may be formed by two optical fibers. 705 and 713 are the cores of the waveguides, while 703 and 711 are the claddings. The operating principles and mechanisms of the resonators in the embodiments of FIGS. 6 and 7 are substantially the same.

The following non-limiting examples further illustrate the present invention.

### EXAMPLE

In this example, two fused silica-based resonator disks, designated as disk A and disk B, were subjected to chlorine treatment of the process of the present invention. The resonators have cylindrical shape and a curved rim. The two disks were measured to have identical center thickness of 0.49 mm, a rim thickness of 0.67 mm, and a radius of curvature of the rim 0.34 mm.

Both disks were subjected to flame polishing of rim before the chlorine treatment of the present invention.

Before chlorine treatment, the two disks were measured for β-OH level using a Bio-Rad FT-IR microscope. To prepare the disk samples for the characterization, they were first cleaned with micro-solution, rinsed with deionized water, then rinsed with isopropyl alcohol and dried. The samples were then placed on the Bio-Rad microscope mapping stage. The microscope using the 15× Cassegrain objective was set up to sample at 16 cm⁻¹ resolution with a signal gain of 4,128. Scans were averaged at each point and ratioed against a spectra of a silica glass at a “dry” point. The beam size was about 100 μm. Measurements were taken at 100 μm intervals at the edge, proceeding through the center region to the opposing edge. Background measurements were taken every fifth sampling from a point from a dry point on reference silica after measurements showed hydroxyl levels to be less than detectable levels. The β-OH level in mm⁻¹ of a certain location of a sample was calculated according to the following equation:

$$β \text{-} OH = \frac{1}{t} log ( \frac{{T}_{ref}}{{T}_{OH}} )$$

where t is the thickness of the sample in mm at the test point, T_{ref} is the light transmission of the sample at reference position (non-OH absorbing—4000 cm⁻¹), T_{OH} is the transmittance of the sample at OH peak (˜3672 cm⁻¹). To calculate the concentration of OH in ppm, Beers-Lambert Law was used:
A=ε·b·c
where A is β-OH in mm⁻¹, b is the sample thickness, ε is a constant of the material and c is the concentration of β-OH.

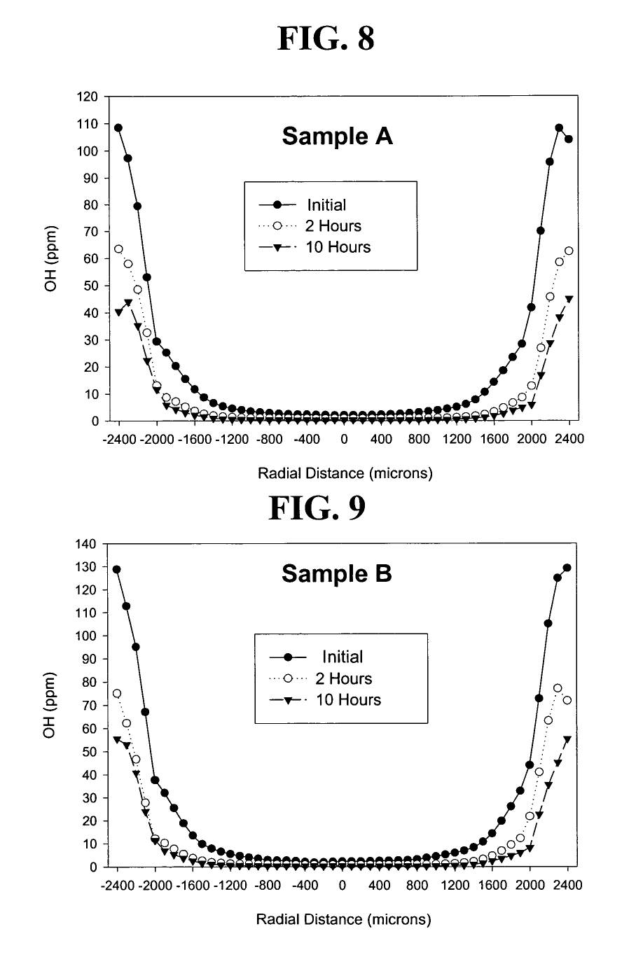

The data β-OH level in ppm of the two samples A and B at different locations were then plotted against the distance from the disk center and shown in FIGS. 8 and 9 (the “Initial” curve), respectively. As can be seen, both samples have a relatively high β-OH level on the rim surface of over 100 ppm. The center of the disks only had negligible amount of β-OH. This indicates that flame polishing of the disks introduced substantial amount of OH to the rim regions of the disks.

Disks A and B were then subjected to a chlorine treatment at 1000° C. in 5% Cl₂/ 95% Helium. The treatment procedure was follows: the disks were heated to and held at 400° C. under 100% He at 1 liter/min for 2 hours, then heated to 1000° C. at a rate of 10° C./min under 100% He at 1 liter/min, then held at this temperature for 2 hours under 5% Cl₂ in He, then allowed to cool to room temperature at a rate of 10° C./min in 100% He at 1 liter/min. Thus the disks were exposed to Cl₂ at 1000° C. for 2 hours. The thus treated disks were then measured for β-OH level in the same way as described supra for untreated disks using the Bio-Rad FT-IR microscope. The β-OH data in ppm obtained for samples A and B were then plotted against the distance from the disk center and reported in FIGS. 8 and 9 (the “2 Hours” curve), respectively.

Subsequently, the same sample disks A and B were subjected to another chlorine treatment. The procedure was follows: the disks were heated to and held at 400° C. under 100% He at 1 liter/min for 2 hours, then heated to 1000° C. at a rate of 10° C./min under 100% He at 1 liter/min, then held at this temperature for 8 hours under 5% Cl₂ in He, then allowed to cool to room temperature at a rate of 10° C./min in 100% He at 1 liter/min. Thus the disks were exposed to Cl₂ at 1000° C. for additional 8 hours, and for 10 hours in total. The thus treated disks were then measured for β-OH level in the same way as described supra for untreated disks using the Bio-Rad FT-IR microscope. The β-OH data in ppm obtained for samples A and B were then plotted against the distance from the disk center and reported in FIGS. 8 and 9 (the “10 Hours” curve), respectively.

As can be seen from FIGS. 8 and 9, after 2 hours of chlorine treatment, the β-OH level at the rim surfaces of the sample disks were reduced to below 70 and 80 ppm, respectively, from about 110 and 130 ppm. After a 10 hour chlorine treatment, the β-OH level at the rim surfaces of the sample disks were further reduced to 45 and 55, respectively. It is also clear that OH reduction in the region near the surface is substantial. Generally, the closer to the surface, the more pronounced the effect of OH level reduction. However, it is clear that throughout the near-surface region within 300 μm from the surface, OH-level was reduced as a result of the 10 hour chlorine treatment. This shows that the process of the present invention using chlorine treatment at an elevated temperature can produce fused silica-based resonators having a low β-OH level.

Surfaces of the disks A and B were observed before chlorine treatment and after final chlorine treatment using a scanning white light interferometer, with no surface degradation observed.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

1. A process for making a consolidated glass article having a low β-OH level at least in the near-surface region, comprising at least one chlorine treatment step of subjecting the consolidated glass of the article to a chlorine-containing atmosphere at an elevated temperature for an effective amount of time.

2. A process in accordance with claim 1, wherein the glass article produced has a β-OH level of lower than 100 ppm in the region within at least 10 μm from the surface of the article.

3. A process in accordance with claim 1, wherein the glass article is made of fused silica glass, optionally doped with alumina, boron oxide, fluorine, germania and/or titania, at an amount of up to 5% by weight each.

4. A process in accordance with claim 1, wherein in the chlorine treatment step, the chlorine-containing atmosphere is selected from chlorine and chlorine/inert gas mixtures, the temperature of the chlorine treatment step is at least 800° C., and the chlorine treatment time is at least 2 hours.

5. A process in accordance with claim 1, wherein the glass article is an optical resonator.

6. A process in accordance with claim 5, wherein the optical resonator has a flame-polished portion.

7. A process in accordance with claim 6, wherein the resonator is a fused silica glass disk, optionally doped with glass modifiers, and the curved rim of the resonator disk is flame polished and has a β-OH level of at least 100 ppm within at least 50 μm from the surface of the rim before the chlorine treatment.

8. A process in accordance with claim 7, wherein in the chlorine treatment step, the fused silica resonator disk is subjected to a chlorine/helium mixture at approximately 1000° C. for at least 2 hours.

9. A process in accordance with claim 1, wherein the chlorine treatment of the consolidated glass is carried out before the glass article is finally formed.

10. A process in accordance with claim 1, wherein the glass article is a planar optical resonator, and the process comprises the following steps in sequence:
(i) providing a cylindrical shaped glass preform having a predetermined size;
(ii) optionally lapping, grinding and/or polishing the preform;
(iii) optionally subjecting the preform to chlorine treatment;
(iv) dicing the preform to form disks of a predetermined thickness;
(iv′) optionally lapping and/or polishing the disks;
(v) optionally subjecting the disks to chlorine treatment;
(vi) hot pressing the disks or thermally reflowing the disks at an elevated temperature; and
(vii) cooling the disks to room temperature.

11. A process in accordance with claim 10, wherein after step (vi), an additional step (vi′) is carried out:
(vi′) subjecting the disks thus formed to chlorine treatment.

12. A process in accordance with claim 10, wherein step (vi) is carried out in an environment essentially free of water.

13. A process in accordance with claim 12, wherein step (vi) is carried out in vacuum.

14. A process in accordance with claim 12, wherein step (vi) is carried out in the presence of an inert gas.

15. A process in accordance with claim 10, wherein step (vi) involves hot pressing at a temperature where the glass has a viscosity less than 10¹⁰ poise.

16. A process in accordance with claim 10, wherein step (vi) involves hot pressing at a pressure ranging from 1,000 to 1,500 psi.

17. A process in accordance with claim 10, wherein step (vi) involves thermal reflowing at a temperature where the glass has a viscosity less than 10⁸ poise.

18. A process in accordance with claim 10, wherein step (vi) involves thermal reflowing at a temperature where the glass has a viscosity ranging from 10⁶ to 10⁷ poise.

19. A glass optical resonator for use in an opto-electronic oscillator having a low OH content at least in the near-surface region.

20. An optical resonator in accordance with claim 19 wherein the resonator is made of optionally doped fused silica glass, and has a β-OH level of less than 80 ppm in the region within at least 10 μm from the surface of the resonator.

21. An optical resonator in accordance with claim 19, wherein the resonator is made of a fused silica material containing additional dopant material selected from the group consisting of boron oxide, fluorine, alumina, germania and titania.

22. An optical resonator in accordance with claim 19, wherein the resonator is made of a fused silica material containing germania, optionally loaded with molecular hydrogen, said silica material being photorefractive.

23. An optical resonator in accordance with claim 22, wherein the resonator contains a photo-induced grating having differing refractive index from that of the rest of the resonator.

24. An optical resonator in accordance with claim 19, wherein the resonator has a planar circular disk or ring shape having an outer diameter of about 1 to 10 mm, and a thickness of from about 20 to 200 μm, and a curved outer rim having a curvature radius of from about 25 to 50 μm.

25. An optical resonator in accordance with claim 24, wherein the resonator has a outer diameter of about 5 mm and a thickness of about 50 to 100 μm.
